(19) United States
(12) Patent Application Publication
(10) Pub. No.: US 2015/0165804 A1
(43) Pub. Date: Jun. 18, 2015

(54) Stamping Device with Interchangeable Stamp Members

(71) Applicant: Jennifer Kim, Jacksonville, FL (US)

(72) Inventor: Jennifer Kim, Jacksonville, FL (US)

(21) Appl. No.: 14/567,246

(22) Filed: Dec. 11, 2014

Related U.S. Application Data
(60) Provisional application No. 61/916,424, filed on Dec. 16, 2013.

(51) Int. Cl. B41K 1/56

(52) U.S. Cl. CPC B41K 1/56

(57) ABSTRACT

A stamping device having interchangeable stamp members. The stamping device includes an elongated, ergonomic handle having a removable panel thereon. The removable panel provides access to a cavity inside of the handle in which additional stamp members for use with the stamping device can be stored. A stamp member support is pivotally secured to an end of the handle by means of a joint, such as a ball and socket joint. The stamp member support can removably hold any of various stamp members by means of a press fit or snap connection therewith. In this way, the stamp member can pivot into various positions so that the stamping device can be used with uneven or irregular surfaces.

### CROSS REFERENCE TO RELATED APPLICATION

This application claims the benefit of U.S. Provisional Application No. 61/916,424 filed on Dec. 16, 2013. The above identified patent application is herein incorporated by reference in its entirety to provide continuity of disclosure.

### BACKGROUND OF THE INVENTION

1. Field of the Invention

The present invention relates to a stamping device. More specifically, the present invention provides a stamping device having a pivoting stamp member support that allows the stamp member thereon to be positioned at a variety of angles so as to be used on uneven or irregular surfaces.

Many traditional stamping devices include only a single stamp member thereon, so that the stamping device can only be used to make one type of marking. Thus, a user needing to make various types of markings must have a multitude of separate stamping devices. Using multiple stamping devices is inconvenient and it can be difficult for the user to store multiple stamping devices in an organized manner.

Further, many stamping devices include a rigid or fixed stamp member so that the stamp can only be used on a flat, planar surface. This prevents the user from being able to use the stamping device on an uneven or irregular surface, such as on the user's hand or arm. Thus, a stamping device having a stamp member adapted to move pivotally to conform to an irregular or uneven surface is desired.

2. Description of the Prior Art

Devices have been disclosed in the prior art that relate to stamping devices. These include devices that have been patented and published in patent application publications. These devices generally relate to stamping devices having removable stamp members. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 1,041,647 to Matthews discloses a holder for changeable type blocks. The device comprises a base holder having a flange on a longitudinal edge thereof and a locking member on an opposing edge. The locking member may include a curved, resilient snap flange. Thus, Matthews discloses a device for removably securing type-blocks thereto, but fails to disclose a stamping device that can pivot, enabling the device to be used on uneven surfaces.

U.S. Pat. No. 2,899,895 to Tannery discloses a rubber stamp device having interchangeable characters thereon. The device comprises a rectangular block having a channel with overhanging eaves, wherein a handle is removably secured to the block. A type strip is insertable into the channel, wherein the type strip comprises a base with a pad of resilient material. Secured to the pad is a rubber strip with various type characters thereon. Thus, Tannery discloses a stamping device with interchangeable characters and fails to disclose a device having a joint allowing for pivotal motion of the stamping device.

U.S. Pat. No. 1,920,058 to Buck discloses a rubber stamp having a printing die removably supported thereon. The device includes a mount that serves to hold printing dies and that includes a handle permanently affixed thereto. A cushion member is positioned on the mount and any of various printing dies can be removably supported on the cushion member within the mount. The printing dies are adapted to fit snugly within the mount. Thus, Buck discloses a stamping device with removable printing die but fails to disclose a stamping device having a joint that allows for pivotal motion of the stamp member.

U.S. Pat. No. 3,012,501 to Munson discloses a hand stamp including a body with a handle thereon. The body includes channels or openings thereon in which rods are positioned. The rods include type elements, such as words, characters, or letters. Thus, Munson fails to disclose a stamping device having a pivoting joint that allows a stamp member to be disposed at any of a variety of angles.

Finally, U.S. Pat. No. 3,988,987 to Ikura et al. discloses a combination stamp having multiple independent stamp elements joined together. The stamp elements each include a stamp frame and a stamp plate, wherein the frame has a vertical interlocking projection on a side surface thereof, and a vertical interlocking groove on an opposing side thereof. Adjacent stamp elements can be secured together by engaging the projection and groove, and a holding member can be fitted over the joined stamp elements. Thus, Ikura discloses a combination stamp and fails to provide a stamping device having a pivoting joint and having removable and interchangeable stamp members.

These prior art devices have several known drawbacks. The devices in the prior art fail to provide a stamp member pivotally disposed on a joint so as to allow the stamping device to be used on uneven or irregular surfaces. While some devices provide interchangeable stamp members, the devices do not allow the stamp members to be secured to the stamping device by means of a press fit or snap connection allowing for ease of installation and removal. Further, the present invention provides a cavity in the handle thereof for storing additional stamp members for use with the stamping device.

In light of the devices disclosed in the prior art, it is submitted that the present invention substantially diverges in design elements from the prior art and consequently it is clear that there is a need in the art for an improvement to existing stamping devices. In this regard the instant invention substantially fulfills these needs.

### SUMMARY OF THE INVENTION

In view of the foregoing disadvantages inherent in the known types of stamping devices now present in the prior art, the present invention provides a new stamping device wherein the same can be utilized for providing convenience for the user when stamping uneven or irregular surfaces, and for using a single stamping device with various types of stamp members having different indicia thereon.

It is therefore an object of the present invention to provide a new and improved stamping device that has all of the advantages of the prior art and none of the disadvantages.

It is another object of the present invention to provide a stamping device having a pivoting joint that allows a stamp member to be disposed at any of a variety of angles so that the stamping device can be used on uneven or irregular surfaces.

Another object of the present invention is to provide a stamping device having an ergonomic handle that can be easily and comfortably grasped by a user.

Yet another object of the present invention is to provide a stamping device that comprises a handle having a cavity therein that is accessible by a removable panel on the handle, wherein the cavity provides storage space.

Another object of the present invention is to provide a stamping device that includes a stamp member pivotally connected to a handle by means of a joint.

A further object of the present invention is to provide a stamping device that includes a stamp member support that allows a user to removably secure any of a variety of stamp members.

An additional object of the present invention is to provide a stamping device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the stamping device of the present invention.

FIG. 2 shows a view of the pivoting joint of the stamping device of the present invention.

FIG. 3 shows a close-up view of a stamp member removed from the stamping device.

FIG. 4 shows a perspective view of the storage compartment of the stamping device.

### DETAILED DESCRIPTION OF THE INVENTION

Reference is made herein to the attached drawings. Like reference numerals are used throughout the drawings to depict like or similar elements of the stamping device. For the purposes of presenting a brief and clear description of the present invention, the preferred embodiment will be discussed as used for stamping an irregular or uneven surface using any of a variety of stamp members having different designs and indicia thereon. The figures are intended for representative purposes only and should not be considered to be limiting in any respect.

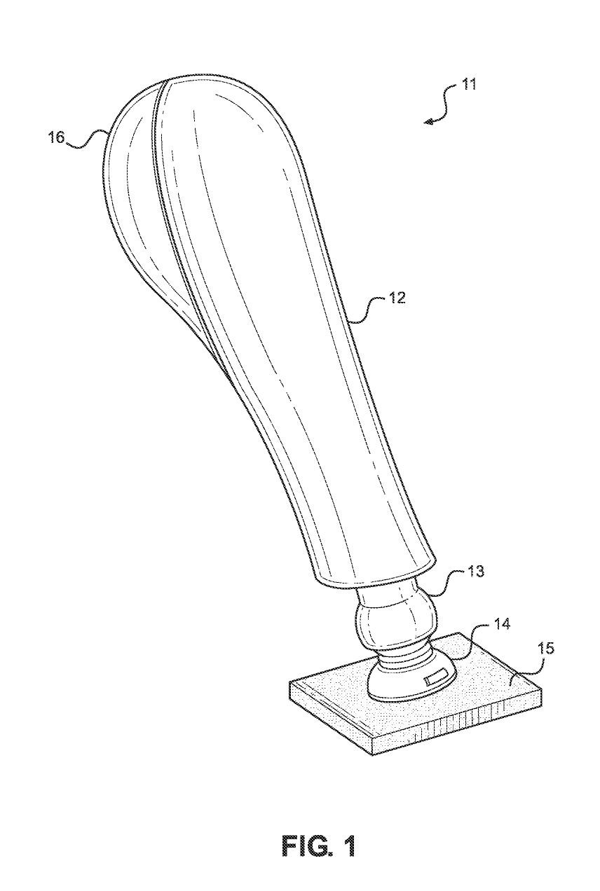

Referring now to FIG. 1, there is shown a perspective view of the stamping device of the present invention. The stamping device 11 comprises an elongated handle 12 for a user to grasp in order to use the device. The handle 12 is preferably ergonomic so that it can be comfortably and easily held in the user's hand. The handle 12 includes a removable panel 16 thereon that provides access to a cavity within the handle 12. At least a portion of the handle 12 is hollow so as to define a cavity therein. The cavity is preferably used to store stamp members having different indicia thereon but may be used for the storage of various other items and accessories.

An end of the handle 12 includes a stamp member support 14 pivotally secured to the handle 12 by a joint 13. The stamp member support 14 is adapted to removably secure any of a variety of stamp members 15 thereon. The stamp member support 14 is adapted to engage with a portion of a stamp member 15 so as to secure the stamp member 15 to the stamping device 11. In this way, the user can use the stamping device with a variety of stamp members 15 in order to make different types of markings. The stamp members 15 may be adapted to create a marking of a signature, a date, a seal or emblem, a logo, or various other indicia on level or uneven surfaces. Thus, the stamp members 15 can include any shape or configuration and can include various indicia or text thereon. In the illustrated embodiment, the stamp member 15 comprises a planar upper surface and a planar lower surface with indicia thereon. In other embodiments, however, it is contemplated that the lower surface of the stamp member 15 may be curved or sloped to further accommodate uneven or irregular surfaces. Further, the stamp members 15 may be composed of a flexible rubber material that allows the stamp member 15 to better conform to the curvature of an uneven or irregular surface.

The joint 13 on the handle 12 is adapted to allow the stamp member 15 secured to the stamp member support 14 to be moved into different positions so that the stamping device 11 can be used on various surfaces having different shapes and configurations. Preferably, the joint 13 comprises a ball and socket joint that allows the stamp member 15 to be moved in all directions such that the stamp member 15 can be disposed at an angle relative to the handle 12. However, in alternate embodiments, other types of joints are used that allow pivotal motion of the stamp member 15.

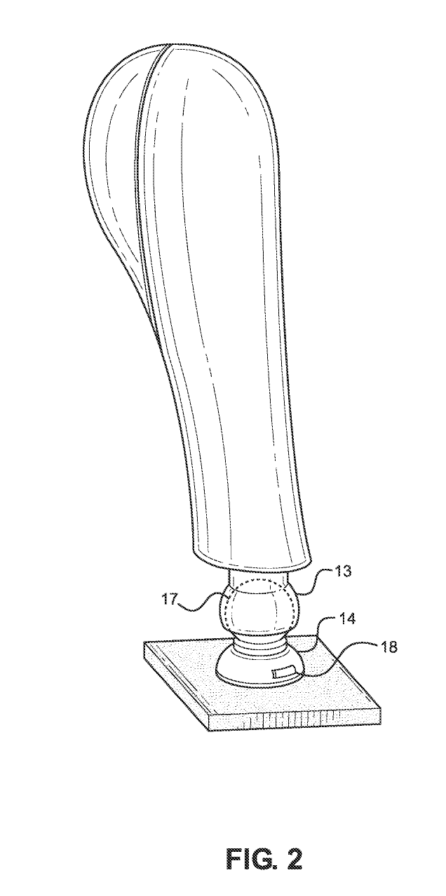

Referring now to FIG. 2, there is shown a view of the pivoting joint of the stamping device of the present invention. The joint 13 is illustrated as a ball and socket joint wherein a spherical ball 17 is partially disposed within a socket, and wherein a stamp member holder 14 is permanently attached to the spherical ball 17. In this way, the stamp member holder 14 can rotate or pivot in various directions as the ball and socket joint allows the stamp member holder 14 to move in 360 degrees. While a ball and socket joint is shown in the illustrated embodiment, various other types of joints can be used that allow the stamp member holder 14 and stamp member 15 thereon to be pivoted or otherwise moved in different directions.

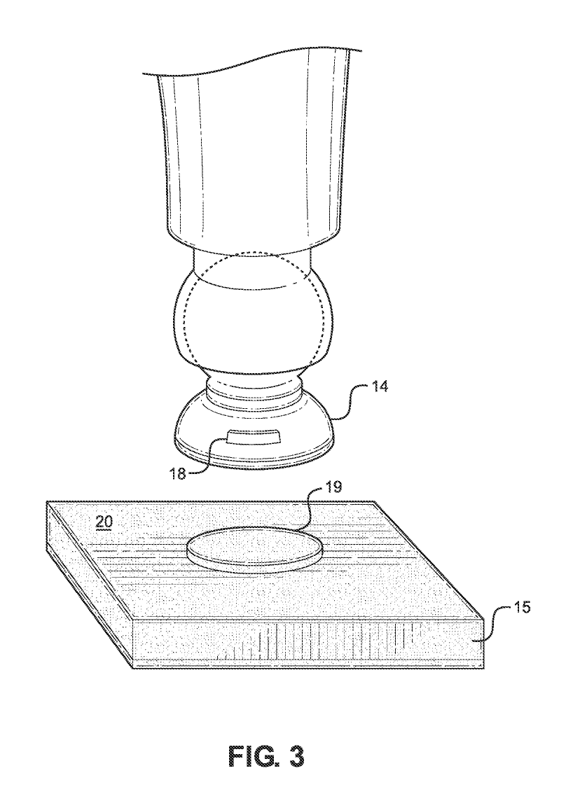

Referring now to FIG. 3, there is shown a close-up view of a stamp member removed from the stamping device. In the illustrated embodiment, the stamp member holder 14 comprises a push-button 18 thereon for disengaging or releasing a stamp member 15 secured thereto. Each stamp member 15 includes a substantially planar upper surface 20 having a protrusion 19 thereon. The protrusion is adapted to be received in the underside of the stamp member holder 14 so as to secure the stamp member 15 thereto. The underside of the stamp member holder 14 includes a recess that is dimensioned to snugly fit the protrusion 19 therein. In this way, stamp members 15 can be easily installed and removed from the stamp member holder 14, and the user can depress the push-button 18 in order to remove a stamp member 15 installed on the stamp member holder 14. Depressing the push-button 18 causes a portion of the push-button 18 to press against the protrusion 19, releasing the protrusion 19 from the recess on the underside of the stamp member holder 14. In alternate embodiments the stamp member 15 can be removably securable to the stamp member holder 14 via any suitable removable connection means such as by a snap fit, a press fit, or the like

Alternatively, the stamp member holder 14 may comprise a cutout thereon. Additionally, the protrusion 19 can comprise a tab on a side thereof, wherein the tab is configured to be partially or entirely inserted through the cutout. In this way, the stamp member 15 can be removably mounted on the stamp member holder 14. Preferably, the tab may be a spring-biased button that can be pressed inward so as to remove the tab and thus the stamp member 15 from the stamp member holder 14.

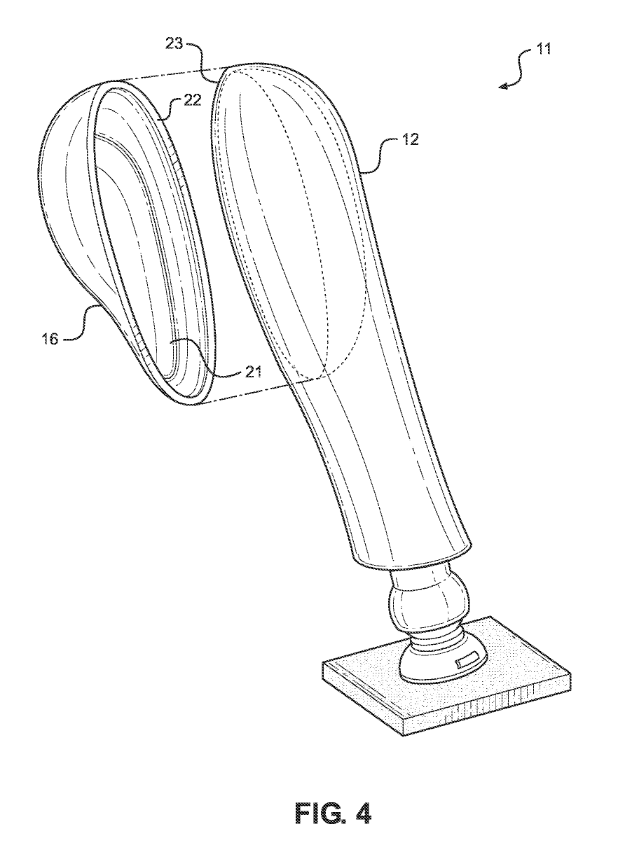

Referring now to FIG. 4, there is shown a perspective view of the storage compartment of the stamping device. The handle 12 includes a removable panel 16 that provides a user with access to a cavity 21 in the handle 12 of the stamping device 11. The removable panel 16 comprises an arcuate shape and defines a portion of an interior cavity 21 in which various articles can be stored. The perimeter 22 of the removable panel 16 can be engaged with the opening 23 of the cavity 21 on the handle 12 and removably secured thereto via a press fit or snap connection. In this way, the removable panel 16 can be easily removed to access the cavity 21 and items held therein. Further, the cavity 21 provides a convenient place to store different stamp members for use with the present invention.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A stamping device, comprising:
an elongated handle having a cavity therein;
a panel removably securable to said handle and adapted to cover and enclose said cavity;
a stamp member support pivotally connected to said elongated handle by means of a joint;
at least one stamp member removably securable to said stamp member support.

2. The stamping device of claim 1, wherein said elongated handle comprises an arcuate shape.

3. The stamping device of claim 1, wherein said joint comprises a ball and socket joint.

4. The stamping device of claim 1, wherein said at least one stamp member comprises a flat upper surface having a protrusion thereon adapted to removably engage with said stamp member support.

5. The stamping device of claim 1, wherein said stamp member support comprises a button for releasing said at least one stamp member.

6. The stamping device of claim 1, wherein said at least one stamp member is composed of a flexible material such that said at least one stamp member can conform to an uneven or irregular surface.
